(19) United States
(12) Patent Application Publication
(10) Pub. No.: US 2025/0203633 A1
(43) Pub. Date: Jun. 19, 2025

(54) METHOD AND APPARATUS FOR TRANSMITTING FEEDBACK DURING WIRELESS COMMUNICATION

(71) Applicant: Nokia Technologies Oy, Espoo (FI)

(72) Inventors: Laura LUQUE SANCHEZ, Aalborg (DK); Ling YU, Espoo (FI); Renato Barbosa ABREU, Aalborg (DK); Timo Erkki LUNTTILA, Espoo (FI); Yong LIU, Shanghai (CN); Nuno Manuel Kiilerich PRATAS, Aalborg (DK); Naizheng ZHENG, Beijing (CN); Torsten WILDSCHEK, Gloucester (GB); Vinh Van PHAN, Oulu (FI); Jianguo LIU, Shanghai (CN)

(21) Appl. No.: 18/845,099

(22) PCT Filed: May 2, 2022
(86) PCT No.: PCT/CN2022/090838

§ 371 Date: Sep. 9, 2024

(51) Int. Cl. H04W 72/25; H04L 1/1812; H04L 1/1829

(52) U.S. Cl. CPC H04W 72/25; H04L 1/1861; H04L 1/1812

(57) ABSTRACT

Embodiments of the present disclosure provide a method and an apparatus for transmitting a feedback during wireless communication. A first apparatus (90) comprises means (910) for performing: receiving a transmission; transmitting a first feedback in response to the transmission. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus. According to embodiments of the present disclosure, an improved manner for transmitting a feedback during wireless communication may be provided. Resource blocks may be reusable for more than one feedback from more than one apparatus. Thus, the number of required RBs to enable interlace/feedback may be reduced.

### TECHNICAL FIELD

The present disclosure relates generally to the technology of communication, and in particular to a method and an apparatus for transmitting a feedback during wireless communication.

### BACKGROUND

This section introduces aspects that may facilitate better understanding of the present disclosure. Accordingly, the statements of this section are to be read in this light and are not to be understood as admissions about what is in the prior art or what is not in the prior art.

In a telecommunication network, such as in any wireless communication network, an apparatus may transmit a feedback in response to a received transmission. In some situations, an interlace may be used for such feedback. Namely, a plurality of resources may be used for that feedback, to meet requirements about some transmission characteristics, such as occupied channel bandwidth, and/or power spectral density, etc.

However, it is possible to cause some issues, when more than one apparatus in the wireless communication network transmits such feedback concurrently.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As mentioned above, when more than one apparatus in the wireless communication network transmits such feedback concurrently, some issues might happen. The transmission capacity of the network might be reduced proportionally by the number of interlaces/repetitions required for such feedback. For example, assuming that 100 resource blocks (RB) are available to be mapped for such feedback and that 10 RBs are required per feedback/interlace, at most 10 feedbacks/interlaces could be established.

Certain aspects of the present disclosure and their embodiments may provide solutions to these or other challenges. There are, proposed herein, various embodiments which address one or more of the issues disclosed herein. Specific method and apparatus for transmitting a feedback during wireless communication may be provided, so as to reduce the number of required RBs to enable interlace/feedback.

A first aspect of the present disclosure provides a first apparatus comprising means for performing: receiving a transmission; transmitting a first feedback in response to the transmission. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

In exemplary embodiments of the present disclosure, the means comprises: at least one processor; and at least one memory including computer program code. The at least one memory and computer program code is configured to, with the at least one processor, cause the performance of the first apparatus.

A second aspect of the present disclosure provides a method performed by a first apparatus. The method comprises: receiving a transmission; transmitting a first feedback in response to the transmission. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

A third aspect of the present disclosure provides a third apparatus comprising means for performing: transmitting a transmission to a first apparatus; receiving a first feedback in response to the transmission, from the first apparatus. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

In exemplary embodiments of the present disclosure, the means comprises: at least one processor; and at least one memory including computer program code. The at least one memory and computer program code is configured to, with the at least one processor, cause the performance of the third apparatus.

A fourth aspect of the present disclosure provides a method performed by a third apparatus. The method comprises: transmitting a transmission to a first apparatus; receiving a first feedback in response to the transmission, from the first apparatus. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

A fifth aspect of the present disclosure provides a computer-readable storage medium storing instructions, which when executed by at least one processor of a first apparatus, cause the at least one processor of the first apparatus to perform: receiving a transmission; transmitting a first feedback in response to the transmission; or when executed by at least one processor of a third apparatus, cause the at least one processor of the third apparatus to perform: transmitting a transmission to the first apparatus; receiving the first feedback in response to the transmission, from the first apparatus. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

Embodiments herein afford many advantages. According to embodiments of the present disclosure, an improved manner for transmitting a feedback during wireless communication may be provided. Resource blocks may be reusable for more than one feedback from more than one apparatus. Thus, the number of required RBs to enable interlace/feedback may be reduced.

For example, assuming that 100 RBs are available to be mapped for PSFCH transmission and that 10 RBs are required per interlace. With the proposed embodiments, up to 91 interlaces can be established, when assuming that the secondary PSFCH are mapped all to the same 9 RBs.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram showing acquisition of the COT by an initiating device via LBT Type 1.

FIG. 2(a) is a diagram showing a first illustration of the allowed gaps for which LBT Type 2 variant to be applicable, for Type 2C; FIG. 2(d) is a diagram showing a second illustration of the allowed gaps for which LBT Type 2 variant to be applicable, for Type 2C; FIG. 2(b) is a diagram showing a first illustration of the allowed gaps for which LBT Type 2 variant to be applicable, for Type 2B; FIG. 2(e) is a diagram showing a second illustration of the allowed gaps for which LBT Type 2 variant to be applicable, for Type 2B; FIG. 2(c) is a diagram showing a first illustration of the allowed gaps for which LBT Type 2 variant to be applicable, for Type 2A; FIG. 2(f) is a diagram showing a second illustration of the allowed gaps for which LBT Type 2 variant to be applicable, for Type 2A.

FIG. 3 is a diagram showing an illustration of when a responding device has to acquire a new COT.

FIG. 4(a) is a diagram showing NR SL resource allocation mode: Mode 1; FIG. 4(b) is a diagram showing NR SL resource allocation mode: Mode 2.

FIG. 5(a) is a diagram showing a SL slot format, a slot with PSCCH/PSSCH; FIG. 5(b) is a diagram showing a SL slot format, a slot with PSCCH/PSSCH and PSFCH.

FIG. 6 is a diagram showing a SL slot with PSCCH/PSSCH and PSFCH.

FIG. 7 is a diagram showing a PSSCH to PSFCH mapping.

FIG. 8 is a diagram showing an interlaced FDM scheme for NR-U uplink (15 kHz subcarrier spacing).

FIG. 9(a) is a block diagram showing an exemplary structure for the first apparatus, which is suitable for perform the method according to embodiments of the disclosure.

FIG. 9(b) is a block diagram showing an exemplary structure for the third apparatus, which is suitable for perform the method according to embodiments of the disclosure.

FIG. 10(a) is a flow chart illustrating a method performed by a first apparatus, in accordance with some embodiments of the present disclosure.

FIG. 10(b) is a flow chart illustrating a method performed by a third apparatus, in accordance with some embodiments of the present disclosure.

FIG. 11 is a block diagram showing an apparatus/computer readable storage medium, according to embodiments of the present disclosure.

FIG. 12(a) is a block diagram showing exemplary apparatus units for the first apparatus, which is suitable for perform the method according to embodiments of the disclosure.

FIG. 12(b) is a block diagram showing exemplary apparatus units for the third apparatus, which is suitable for perform the method according to embodiments of the disclosure.

FIG. 13 is a diagram showing a partial non-orthogonal interlaced FDM PSFCH.

FIG. 14(a) is a diagram showing quasi-uniform interlace FDM PSFCH for NR-U (subcarrier spacing 15 KHz), with a set of RBs for secondary PSFCH; FIG. 14(b) is a diagram showing quasi-uniform interlace FDM PSFCH for NR-U (subcarrier spacing 15 KHz), with UE1 PSFCH primary and secondary interlace; FIG. 14(c) is a diagram showing quasi-uniform interlace FDM PSFCH for NR-U (subcarrier spacing 15 KHz), with UE2 PSFCH primary and secondary interlace.

### DETAILED DESCRIPTION

The embodiments of the present disclosure are described in detail with reference to the accompanying drawings. It should be understood that these embodiments are discussed only for better understand, rather than limitations on the scope of the present disclosure. The described features, advantages, and characteristics of the disclosure may be combined in any suitable manner in one or more embodiments.

Generally, all terms used herein are to be interpreted according to their ordinary meaning in the relevant technical field, unless a different meaning is clearly given and/or is implied from the context in which it is used. The steps of any methods disclosed herein do not have to be performed in the exact order disclosed, unless clearly given and/or implied from the context. Any feature of any of the embodiments disclosed herein may be applied to any other embodiment, wherever appropriate.

As used herein, the term “network” or “communication network” refers to a network following any suitable communication standards (such for an internet network, or any wireless network). For example, wireless communication standards may comprise new radio (NR), long term evolution (LTE), LTE-Advanced, WLAN, etc. In the following description, the terms “network” and “system” can be used interchangeably.

The term “network node” used herein refers to a network device or network entity or network function or any other devices (physical or virtual) in a communication network. For example, the network entity in the network may include a base station (BS), an access point (AP) a controller or any other suitable device in a wireless communication network. The BS may be, for example, a node B (NodeB or NB), an evolved NodeB (eNodeB or eNB), a next generation NodeB (gNodeB or gNB), a relay, a low power node such as a femto, a pico, and so forth.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The terminal device/UE may include, but not limited to, a mobile phone, a cellular phone, a smart phone, a wearable device, a vehicle-mounted wireless terminal device, a vehicle, and the like. In the following description, the terms “terminal device”, “terminal”, “user equipment” and “UE” may be used interchangeably.

As one example, a terminal device may represent a UE configured for communication in accordance with one or more communication standards promulgated by the 3GPP, such as 3GPP′ LTE standard or NR standard.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

One exemplary scenario for a plurality of UE to transmit signals with interlaces may be sidelink, particularly on unlicensed spectrum. Some embodiments will be particularly applicable to such scenario. But it should be understood that embodiments in the present disclosure may be also applicable to other scenarios.

For example, in recent 3GPP RAN1#94e meeting, the R18 work item (RP-213678) on sidelink enhancements (SL-U is one critical part) was approved with the following objectives related to SL-U:
2. Study and specify support of sidelink on unlicensed spectrum for both mode 1 and mode 2 where Uu operation for mode 1 is limited to licensed spectrum only [RAN1, RAN2, RAN4]
   Channel access mechanisms from NR-U shall be reused for sidelink unlicensed operation
      Assess the applicability of sidelink resource reservation from Rel-16 Rel-17 to sidelink unlicensed operation within the boundaries of unlicensed channel access mechanism and operation.
         No specific enhancements for Rel-17 resource allocation mechanisms
         If the existing NR-U channel access framework does not support the required SL-U functionality, WGs will make appropriate recommendations for RAN approval.
   Physical channel design framework: Required changes to NR sidelink physical channel structures and procedures to operate on unlicensed spectrum
      The existing NR sidelink and NR-U channel structure shall be reused as the baseline.
   No specific enhancements for existing NR SL feature
   The study should focus on FRI unlicensed bands (n46 and n96/n102) and is to be completed by RAN#98.

ETSI (European Telecommunication Standards Institute) EN (European Standard) 301 893 V2.1.1 (2017-05): RLAN Harmonised Standard covering the essential requirements of article 3.2 of Directive 2014/53/EU is considered as the main relevant regulation/standards.

In sub-7 GHz unlicensed bands, the new radio (NR) coexistence with other systems (e.g., IEEE (Institute of Electrical and Electronics Engineers) 802.11, wireless local area network, WLAN) is ensured via a Listen Before Talking (LBT) channel access mechanism. Where, a user equipment (UE) intending to perform a sidelink (SL) transmission needs first to successfully complete an LBT check, before being able to initiate transmission.

For a UE to pass an LBT check then it must observe the channel as available for a number of consecutive Clear Channel Assessment (CCA) slots. In sub-7 GHz the duration of these slots is 9 μs. The UE deems the channel as available in a CCA slot if the measured power (i.e., the collected energy during the CCA slot) is below a regulatory specified threshold (which can depend on the operating band and geographical region).

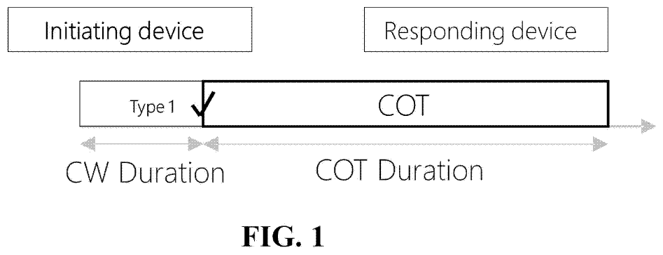

FIG. 1 is a diagram showing acquisition of the COT by an initiating device via LBT Type 1.

When a UE initiates the communication (i.e., the UE takes the role of initiating device), then this UE has to acquire the “right” to access the channel for a certain period of time-denoted in the regulations as the Channel Occupancy Time (COT)—by applying an “extended” LBT procedure where the channel must be deemed as free for the entire duration of a Contention Window (CW). This “extended” LBT procedure, is commonly known as LBT Type 1 as specified in TS 37.213 (3GPP TS 37.213 V17.1.0 (2022-03)). This procedure is illustrated in the FIG. 1.

The duration of both the COT and CW depends on the Channel Access Priority Class (CAPC) associated with the UE's traffic, as shown in Table 1. Control plane traffic (such as PSCCH) is transmitted with p=1, while user plane traffic has p>1. In Table 1, it is depicted that the LBT Type 1 details for the Uu uplink (UL) case, but it is noted that the downlink (DL) case LBT Type 1 parameters could also in principle be adopted in SL.

TABLE 1
From TS 37.213 V17.1.0 “Table 4.2.1-1: Channel Access Priority
Class (CAPC) for UL”. The contention window length in CCA
slots associated with each CAPC has a minimum (CW_{min, p})
and maximum (CW_{max, p}). The duration of the COT is
given by T_{ulm cot, p}.

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

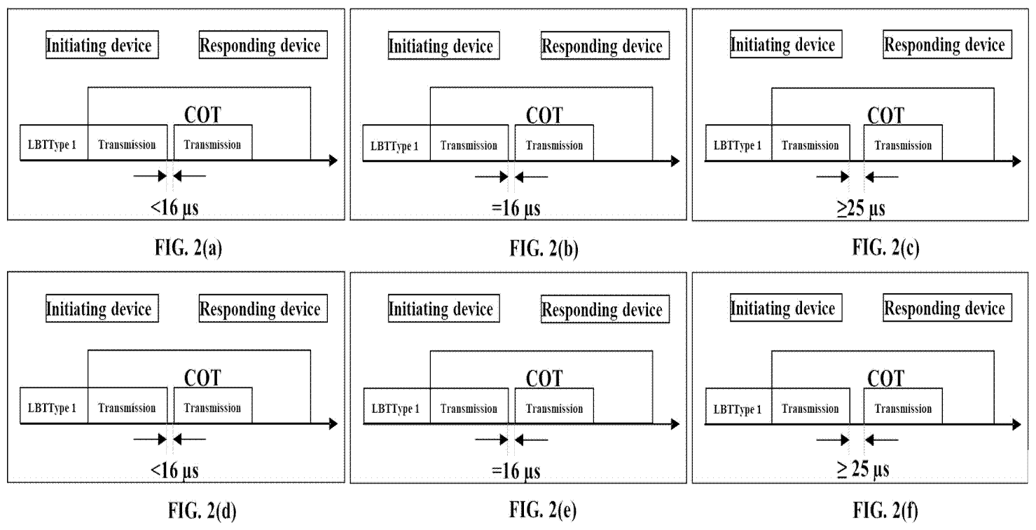

FIG. 2(a) is a diagram showing a first illustration of the allowed gaps for which LBT Type 2 variant to be applicable, for Type 2C; FIG. 2(d) is a diagram showing a second illustration of the allowed gaps for which LBT Type 2 variant to be applicable, for Type 2C; FIG. 2(b) is a diagram showing a first illustration of the allowed gaps for which LBT Type 2 variant to be applicable, for Type 2B; FIG. 2(e) is a diagram showing a second illustration of the allowed gaps for which LBT Type 2 variant to be applicable, for Type 2B; FIG. 2(c) is a diagram showing a first illustration of the allowed gaps for which LBT Type 2 variant to be applicable, for Type 2A; FIG. 2(f) is a diagram showing a second illustration of the allowed gaps for which LBT Type 2 variant to be applicable, for Type 2A.

FIGS. 2(a), 2(b) and 2(c) show the case where the gap is between the two transmissions both from the initiating UE, while FIGS. 2(d), 2(e), and 2(f) show the case that the gap is between the two different transmissions from the initiating UE and the responding UE correspondingly).

The UE initiating the transmission (the initiating device) upon successfully completing the LBT Type 1 and performing a transmission, acquires the COT with duration associated with the corresponding CAPC. The acquired COT is valid even in the case where the initiating device pauses its transmission, although if the initiating device wants to perform a new transmission (within the COT) it is still required to perform a “reduced” LBT procedure. This “reduced” LBT procedure, is commonly known as LBT Type 2 (TS 37.213 V17.1.0), with the following variants:
Type 2A (25 μs LBT)—for SL transmissions within the initiating device acquired COT (in case the gap between two SL transmissions is >25 μs, as well for SL transmissions following another SL transmission), depicted in FIG. 2(c) and FIG. 2(f);
Type 2B (16 μs LBT)—for SL transmission within the initiating device acquired COT (can only be used for SL transmissions following another SL with gap exactly equal to 16 μs), depicted in FIG. 2(b) and FIG. 2(e);
Type 2C (no LBT)—can only be used for SL transmission following another SL, with a gap <16 μs and the allowed duration of the SL transmission≤584 μs), depicted in FIG. 2(a) and FIG. 2(d).

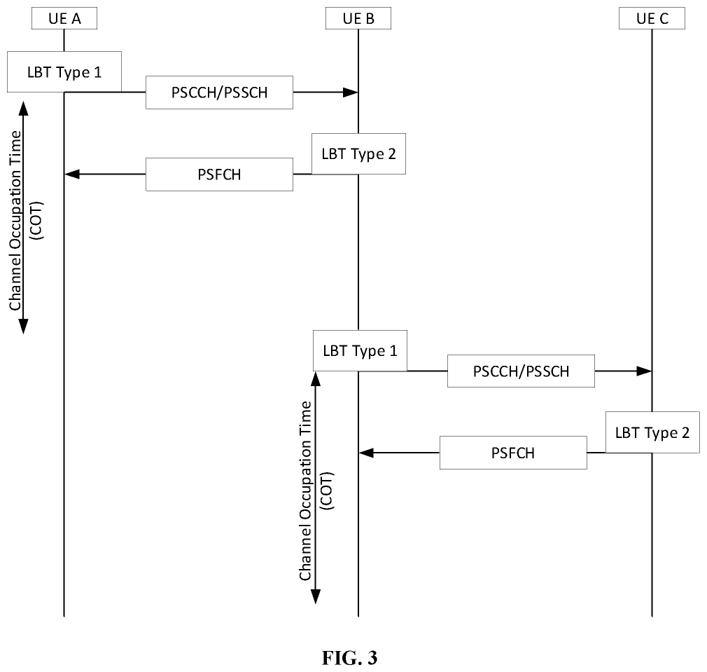

FIG. 3 is a diagram showing an illustration of when a responding device has to acquire a new COT.

The initiating device can share its acquired COT with its intended receiver (the responding device). For this purpose, the initiating device shall inform (e.g., via control signaling) the responding device about the duration of this COT. The responding device uses then this information to decide which type of LBT it should apply upon performing a transmission for which the intended receiver is the initiating device. In case the responding device transmission falls outside the COT, then the responding device will have to acquire a new COT using the LBT Type 1 with the appropriate CAPC. These concepts/restrictions are illustrated in FIG. 3.

As shown in the FIG. 3, UE A acquires a COT using the LBT Type 1. UE A transmit PSCCH/PSSCH to the UE B. Then UE B uses the LBT Type 2 and transmits PSFCH to the UE A. As another procedure, UE B acquires a COT using the LBT Type 1. UE B transmit PSCCH/PSSCH to the UE C. Then UE C uses the LBT Type 2 and transmits PSFCH to the UE B.

During 3GPP Rel (Release)-16, NR sidelink (SL) has been designed to facilitate a user equipment (UE) to communicate with other nearby UE(s) via direct/SL communication. Two resource allocation modes have been specified, and a SL transmitter (TX) UE is configured with one of them to perform its NR SL transmissions. These modes are denoted as NR SL mode 1 and NR SL mode 2. In mode 1, a sidelink transmission resource is assigned (scheduled) by the network (NW) to the SL TX UE, while a SL TX UE in mode 2 autonomously selects its SL transmission resources.

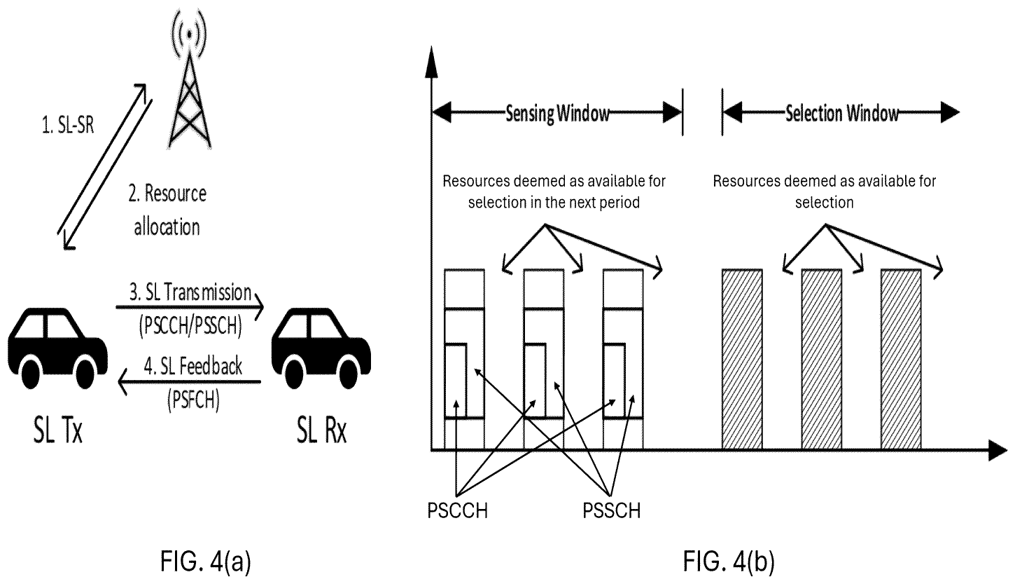

FIG. 4(a) is a diagram showing NR SL resource allocation mode: Mode 1; FIG. 4(b) is a diagram showing NR SL resource allocation mode: Mode 2.

In mode 1, where the gNB is responsible for the SL resource allocation, the configuration and operation are similar to the one over the Uu interface (which depicted in FIG. 4(a) and FIG. 4(b)). The MAC level details of this procedure are given in section 5.8.3 of 38.321 (3GPP TS 38.321 V17.0.0 (2022-03)).

The SL Tx UE may transmit SL-SR (sidelink scheduling request) to the gNB, and receive resource allocation from the gNB. Then, the SL Tx UE may make SL transmission (including PSCCH/PSSCH) to the SL Rx UE, and receive SL Feedback (including PSFCH) from the SL Rx UE.

In mode 2, the SL UEs perform autonomously the resource selection with the aid of a sensing procedure. More specifically, a SL TX UE in NR SL mode 2 first performs a sensing procedure over the configured SL transmission resource pool(s) (such as, during a sensing window), in order to obtain the knowledge of the reserved resource(s) by other nearby SL TX UE(s). Based on the knowledge obtained from sensing, the SL TX UE may select resource(s) from the available SL resources (such as, during the selection window), accordingly. In order for a SL UE to perform sensing and obtain the necessary information to receive a SL transmission, it needs to decode the sidelink control information (SCI). In release 16, the SCI associated with a data transmission includes a 1^{st}-stage SCI and 2^{nd}-stage SCI, and their contents are standardized in 3GPP TS 38.212 (3GPP TS 38.212 V17.1.0 (2022-03)).

The SCI follows a 2-stage SCI structure, whose main motivation is to support the size difference between the SCIs for various NR-V2X (vehicle to everything) SL service types (e.g., broadcast, groupcast and unicast).

The 1^{st}-stage SCI, SCI format 1-A, carried by PSCCH and contains:
information to enable sensing operations;
information needed to determine resource allocation of the PSSCH and to decode 2^{nd}-stage SCI.

The 2^{nd}-stage SCI, SCI format 2-A and 2-B, carried by PSSCH (multiplexed with SL-SCH) and contains:
Source and destination identities;
information to identify and decode the associated SL-SCH TB (transport block);
control of HARQ (Hybrid Acknowledge Request) feedback in unicast/groupcast
trigger for CSI feedback in unicast.

The configuration of the resources in the sidelink resource pool defines the minimum information required for a RX UE to be able to decode a transmission, which includes the number of sub-channels, the number of PRBs per sub-channels, the number of symbols in the PSCCH, which slots have a PSFCH and other configuration aspects not relevant to embodiments of the present disclosure.

However, the details of the actual sidelink transmission (i.e., the payload) is provided in the PSCCH (1^{st}-stage SCI) for each individual transmission, which includes: The time and frequency resources, the DMRS (DeModulation Reference Signal) configuration of the PSSCH, the MCS (Modulation and Coding Scheme), PSFCH, among others.

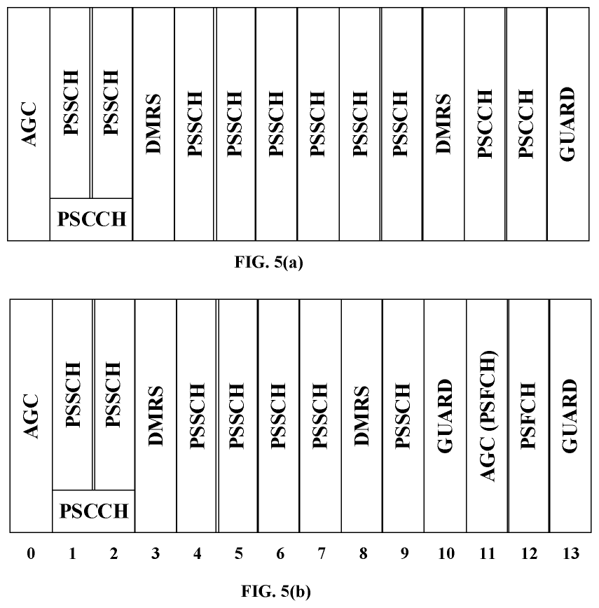

FIG. 5(a) is a diagram showing a SL slot format, a slot with PSCCH/PSSCH; FIG. 5(b) is a diagram showing a SL slot format, a slot with PSCCH/PSSCH and PSFCH.

An example of the SL slot structure is depicted in FIG. 5(a) and FIG. 5(b), where it is shown a slot with PSCCH/PSSCH and a slot with PSCCH/PSSCH where the last symbols are used for PSFCH.

Generally, the SL slot structure may include any of AGC (automatic gain control), PSSCH, PSCCH, DMRS, GUARD, PSFCH, etc.

The configuration of the PSCCH (e.g., DMRS, MCS, number of symbols used) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1^{st}-stage SCI which is the payload sent within the PSCCH and follows the configuration depicted in Table 2 (Table 8.4.1.1.2-1: PSSCH DM-RS time-domain location, 3GPP TS 38.211 V17.1.0 (2022-03)).

TABLE 2
PSSCH DMRS configurations based on the number
of used symbols and duration of the PSCCH.

| | DM-RS position l̅ | | | | | |
|---|---|---|---|---|---|---|
| | PSCCH duration 2 symbols | | | PSCCH duration 3 symbols | | |
| l_{d} in | Number of PSSCH DM-RS | | | Number of PSSCH DM-RS | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, | 4, 10 | 1, 5, 9 | 1, 4, |
| | | | 7, 10 | | | 7, 10 |
| 12 | 3, 10 | 1, 5, 9 | 1, 4, | 4, 10 | 1, 5, 9 | 1, 4, |
| | | | 7, 10 | | | 7, 10 |
| 13 | 3, 10 | 1, 6, 11 | 1, 4, | 4, 10 | 1, 6, 11 | 1, 4, |
| | | | 7, 10 | | | 7, 10 |

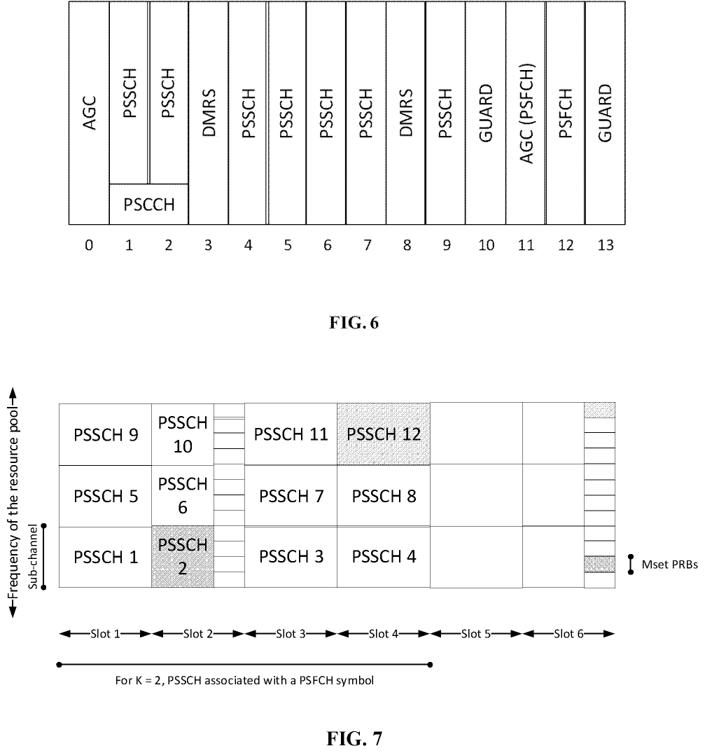

FIG. 6 is a diagram showing a SL slot with PSCCH/PSSCH and PSFCH.

The PSFCH was introduced during Rel-16 to enable HARQ feedback over the sidelink from a UE that is the intended recipient of a PSSCH transmission (i.e., the RX UE) to the UE that performed the transmission (i.e., the TX UE). Within a PSFCH, a Zadoff-Chu sequence in one PRB is repeated over two OFDM symbols, the first of which can be used for AGC, near the end of the sidelink resource in a slot. An example slot format of PSCCH, PSSCH, and PSFCH is provided in FIG. 6. The Zadoff-Chu sequence as base sequence is (pre-) configured per sidelink resource pool.

The time resources for PSFCH are (pre-) configured to occur once every 0, 1, 2, or 4 slots according to 38.331 (3GPP TS 38.331 V16.8.0 (2022-03)). The HARQ feedback resource (PSFCH) is derived from the resource location of PSCCH/PSSCH.

For PSSCH-to-HARQ timing, there is a configuration parameter K with the unit of slot. The time occasion for PSFCH is determined from K. For a PSSCH transmission with its last symbol in slot n, HARQ feedback is in slot n+a where a is the smallest integer larger than or equal to K with the condition that slot nta contains PSFCH resources. The time gap of at least K slots allows considering the RX UE's processing delay in decoding the PSCCH and generating the HARQ feedback. K can be equal to 2 or 3, and a single value of K can be (pre-) configured per resource pool. This allows several RX UEs using the same resource pool to utilize the same mapping of PSFCH resource(s) for the HARQ feedback. With the parameter K, the N PSSCH slots associated with a slot with PSFCH can be determined.

FIG. 7 is a diagram showing a PSSCH to PSFCH mapping.

As an example, illustrated in FIG. 7, the period of PSFCH resources is configured as N=4 (i.e., there will be 4 PSSCH slots associated with the PSFCH), and K (the sl-MinTimeGapPSFCH) is configured as 2. With L sub-channels in a resource pool and N PSSCH slots associated with a slot containing PSFCH, there are then N*L sub-channels associated with a PSFCH symbol. With M PRBs available for PSFCH in a PSFCH symbol, there are M PRBs available for the HARQ feedback of transmissions over N*L sub-channels.

With M configured to be a multiple of N*L, then a distinct set of Mₛₑₜ=M/(N*L) PRBs can be associated with the HARQ feedback for each sub-channel within a PSFCH period. The first set of Mₛₑₜ PRBs among the M PRBs available for PSFCH are associated with the HARQ feedback of a transmission in the first sub-channel in the first slot. The second set of Mₛₑₜ PRBs are associated with the HARQ feedback of a transmission in the first sub-channel in the second slot and so on.

This is illustrated in FIG. 7 with N=4, L=3 and with all PRBs in a PSFCH symbol available for PSFCH. In this example, the HARQ feedback for a transmission at PSSCH x is sent on the set x of Mₛₑₜ PRBs in the corresponding PSFCH symbol, with x=1, . . . , 12.

A set of Mₛₑₜ PRBs associated with a sub-channel are shared among multiple RX UEs in case of ACK/NACK feedback for groupcast communications (option 2) or in the case of different PSSCH transmissions in the same sub-channel.

For each PRB available for PSFCH, there are Q cyclic shift pairs available to support the ACK or NACK feedback of Q RX UEs within the PRB. For a resource pool, the number of cyclic shift pairs Q is (pre-) configured and can be equal to 1, 2, 3 or 6.

The number F of PSFCH resources available for supporting the HARQ feedback of a given transmission (in TS 38.213 (3GPP TS 38.213 V17.1.0 (2022-03)) F is denoted as R_{PRB,CS}^{PSFCH}) can be computed. With each PSFCH resource used by one RX UE, F available PSFCH resources can be used for the ACK/NACK feedback of up to F RX UEs.

The F PSFCH resources available for multiplexing the HARQ feedback for the PSSCH can be determined based on two options:
a) either based on the L PSSCH sub-channels used by a PSSCH, where the F can be computed as:
   F=L PSSCH*Mₛₑₜ*Q PSFCHs (associated with the L PSSCH sub-channels of a PSSCH)
   Where,
      L PSSCH sub-channels of a PSSCH;
      Mₛₑₜ PRBs for PSFCH associated with each sub-channel; and
      Q cyclic shift pairs available in each PRB.
b) or based only on the starting sub-channel used by a PSSCH (i.e., based only on one sub-channel for the case when L PSSCH>1).
   F=Mₛₑₜ*Q PSFCHs (associated with the starting sub-channel of a PSSCH)
   Where,
      Mₛₑₜ PRBs for PSFCH associated with each sub-channel; and
      Q cyclic shift pairs available in each PRB.

Similarly to the PUCCH in Rel. 15 NR Uu, the available F PSFCH resources are indexed based on a PRB index (frequency domain) and a cyclic shift pair index (code domain).

The mapping of the PSFCH index i (i=1, 2, . . . ,F) to the PRBs and to the Q cyclic shift pairs is such that the PSFCH index i first increases with the PRB index until reaching the number of available PRBs for PSFCH. Then, it increases with the cyclic shift pair index, again with the PRB index and so on.

Among the F PSFCHs available for the HARQ feedback of a given transmission, an RX UE selects for its HARQ feedback the PSFCH with index i given by:

$$i = ( {T}_{ID} + {R}_{ID} ) mod F$$

where T_{1D} is the Layer 1 ID of the TX UE (indicated in the 2^{nd}-stage SCI). R_{1D}=0 for unicast ACK/NACK feedback and groupcast NACK-only feedback (option 1).

For groupcast ACK/NACK feedback (option 2), R_{1D} is equal to the RX UE identifier within the group, which is indicated by higher layers. For a number X of RX UEs within a group, the RX UE identifier is an integer between 0 and X-1. An RX UE determines which PRB and cyclic shift pair should be used for sending its HARQ feedback based on the PSFCH index i. The RX UE uses the first or second cyclic shift from the cyclic shift pair associated with the selected PSFCH index i in order to send NACK or ACK, respectively.

By RX UEs selecting PSFCHs with index i a TX UE can distinguish the HARQ feedback of different RX UE(s) (via the RX UE identifier, e.g., for groupcast option 2) and the HARQ feedback intended for the TX UE (via the Layer 1 ID of the TX UE, e.g., for unicast). As R_{1D}=0 for groupcast option 1, the RX UEs select the same PSFCH index i for their NACK-only feedback based solely on the Layer 1 ID TX UE identifier TID.

The PSFCH is transmitted in response to the reception of a PSCCH/PSSCH transmission (when the receiver is the intended receiver) and therefore it as an associated PSFCH power control procedure as specified in TS 38.213 V17.0.0 (2021-12). The UE can perform multiple PSFCH transmissions in the same slot and each one is a narrow band transmission.

Taking a closer look at the PSFCH power control (see procedure below), when the UE operates under network coverage and the dl-P0-PSFCH is provided, then the power control is towards the serving cell and based on the number of PSFCH transmission in the same slot and not based on the required power towards the intended receiver. When the UE operates outside network coverage or the dl-P0-PSFCH is not provided (e.g., the sidelink resource pool takes place in resources not shared with Uu's UL) then the power control is only dependent on the number of PSFCH transmission in the same slot and not based on the required power towards the intended receiver. In other words, if the UE only has to perform one PSFCH transmission and no dl-P0-PSFCH is provided (i.e., no need to do power control towards the serving cell) then the UE will apply maximum transmission power given by PCMAX.

3GPP TS 38.213 V17.0.0 (2021-12) defines as follows.

16.2.3 PSFCH

A UE with N_{sch, Tx, PSFCH} scheduled PSFCH transmissions, and capable of transmitting a maximum of
N_{max, PSFCH} PSFCHs, determines a number N_{Tx, PSFCH} of simultaneous PSFCH transmissions and a power
P_{PSFCH, k}(i) for a PSFCH transmission k, 1 ≤ k ≤ N_{Tx, PSFCH}, on a resource pool in PSFCH transmission
occasion i on active SL BWP b of carrier f as

| | |
|---|---|
| - | if dl-P0-PSFCH is provided, |

P_{PSFCH, one} = P_{O, PSFCH} + 10 log₁₀(2^{μ}) + α_{PSFCH} · PL [dBm]

| where | |
|---|---|
| - | P_{O, PSFCH} is a value of dl-P0-PSFCH |
| - | α_{PSFCH} is a value of dl-Alpha-PSFCH, if provided; else, α_{PSFCH} = 1 |

| | |
|---|---|
| - | PL = PL_{b, f, c}(q_{d}) when the active SL BWP is on a serving cell c, as described in clause 7.1.1 except |
| | that |

| | |
|---|---|
| - | the RS resource is the one the UE uses for determining a power of a PUSCH transmission |
| | scheduled by a DCI format 0_0 in serving cell c when the UE is configured to monitor PDCCH for |
| | detection of DCI format 0_0 in serving cell c |
| - | the RS resource is the one corresponding to the SS/PBCH block the UE uses to obtain MIB when |
| | the UE is not configured to monitor PDCCH for detection of DCI format 0_0 in serving cell c |

| | |
|---|---|
| - | if N_{sch, Tx, PSFCH} ≤ N_{max, PSFCH} |

| | |
|---|---|
| - | if P_{PSFCH, one} + 10log₁₀(N_{sch, Tx, PSFCH}) ≤ P_{CMAX}, where P_{CMAX} is determined for N_{sch, Tx, PSFCH} |
| | PSFCH transmissions according to [8-1, TS 38.101-1] |

| | |
|---|---|
| - | N_{Tx, PSFCH} = N_{sch, Tx, PSFCH} and P_{PSFCH, k}(i) = P_{PSFCH, one} [dBm] |

| | |
|---|---|
| - | else |

| | |
|---|---|
| - | UE autonomously determines N_{Tx, PSFCH} PSFCH transmissions with ascending priority order as |
| | described in clause 16.2.4.2 such that N_{Tx, PSFCH} ≥ max(1, Σᵢ₌₁^{K} Mᵢ) where Mᵢ is a number of |
| | PSFCHs with priority value i and K is defined as |

| | |
|---|---|
| - | the largest value satisfying P_{PSFCH, one} + 10log₁₀(max(1, Σᵢ₌₁^{K} Mᵢ)) ≤ P_{CMAX} where P_{CMAX} is |
| | determined according to [8-1, TS 38.101-1] for transmission of all PSFCHs assigned with |
| | priority values 1, 2, ..., K, if any |
| - | zero, otherwise |

and

P_{PSFCH, k}(i) = min(P_{CMAX} − 10log₁₀(N_{Tx, PSFCH}), P_{PSFCH, one}) [dBm]

where P_{CMAX} is defined in [8-1, TS 38.101-1] and is determined for the N_{Tx, PSFCH} PSFCH

transmissions

| | |
|---|---|
| - | else |

| | |
|---|---|
| - | the UE autonomously selects N_{max, PSFCH} PSFCH transmissions with ascending priority order as |
| | described in clause 16.2.4.2 |

| | |
|---|---|
| - | if P_{PSFCH, one} + 10log₁₀(N_{max, PSFCH}) ≤ P_{CMAX}, where P_{CMAX} is determined for the N_{max, PSFCH} |
| | PSFCH transmissions according to [8-1, TS 38.101-1] |

| | |
|---|---|
| - | N_{Tx, PSFCH} = N_{max, PSFCH} and P_{PSFCH, k}(i) = P_{PSFCH, one} [dBm] |

| | |
|---|---|
| - | else |

| | |
|---|---|
| - | the UE autonomously selects N_{Tx, PSFCH} PSFCH transmissions in ascending order of |
| | corresponding priority field values as described in clause 16.2.4.2 such that N_{Tx, PSFCH} ≥ |
| | max(1, Σᵢ₌₁^{K} Mᵢ) where Mᵢ is a number of PSFCHs with priority value i and K is defined as |

| | |
|---|---|
| - | the largest value satisfying P_{PSFCH, one} + 10log₁₀(max(1, Σᵢ₌₁^{K} Mᵢ)) ≤ P_{CMAX} where P_{CMAX} |
| | is determined according to [8-1, TS 38.101-1] for transmission of all PSFCHs assigned |
| | with priority values 1, 2, ..., K, if any |
| - | zero, otherwise |

and
P_{PSFCH, k}(i) = min(P_{CMAX} − 10log₁₀(N_{Tx, PSFCH}), P_{PSFCH, one}) [dBm]
where P_{CMAX} is determined for the N_{Tx, PSFCH} simultaneous PSFCH transmissions according to
[8-1, TS 38.101-1]

| | |
|---|---|
| - | else |

P_{PSFCH, k}(i) = P_{CMAX} − 10log₁₀(N_{Tx, PSFCH}) [dBm]

where the UE autonomously determines N_{Tx, PSFCH} PSFCH transmissions with ascending priority order as

```
    described in clause 16.2.4.2 such that N_{Tx, PSFCH} ≥ 1 and where P_{CMAX} is determined for the N_{Tx, PSFCH}
    PSFCH transmissions according to [8-1, TS 38.101-1].
```

The scope of NR in unlicensed spectrum was limited to below 7 GHz bands. For this frequency range, the following spectrum regulatory requirements for the design of UL physical channels are captured from EU regulations [1] (ETSI EN 301.893):
ETSI specifies that Occupied Channel Bandwidth (OCB) shall be between 80% and 100% of the declared Nominal Channel Bandwidth.
As per updated ETSI regulation, during a Channel Occupancy Time (COT), equipment may operate temporarily with an Occupied Channel Bandwidth of less than 80% of its Nominal Channel Bandwidth with a minimum of 2 MHz.
Regulations on the maximum power spectral density are typically stated with a resolution bandwidth of 1 MHz. The ETSI specification requires a maximum Power Spectral Density (PSD) of 10 dBm/MHz for 5150-5350 MHz. Section 5.4.4.2.1.3.3 in [1] requires 10 KHz resolution for testing the 1 MHz PSD constraint and, thus, the maximum PSD constraint should be met in any occupied 1 MHz bandwidth.
In addition, the regulations impose a band specific total maximum transmission power in terms of EIRP, e.g., ETSI has EIRP limit of 23 dBm for 5150-5350 MHz [1].

[1] ETSI EN 301.893, 5 GHZ RAN; Harmonised Standard covering the essential requirements of article 3.2 of Directive 2014/53/EU V2.1.1, 2017-05.

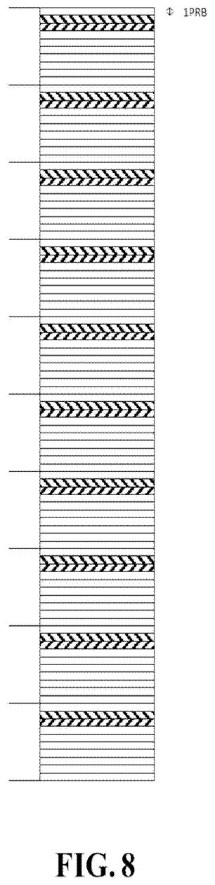

FIG. 8 is a diagram showing an interlaced FDM scheme for NR-U uplink (15 kHz subcarrier spacing).

The regulatory limitations in terms of OCB and PSD guided the design choices for the uplink channels of NR-unlicensed system. The interlaced FDM scheme was adopted, as shown in the following figure. In interlaced FDM, specified in TS38.214 (3GPP TS 38.214 V17.1.0 (2022-03)) as UL resource allocation type 2, the UL resources are allocated in interlaces of 10 equidistant PRBs. The number of interlaces is 10 for 15 kHz SCS (SubCarrier Spacing) and 5 for 30 KHz SCS.

The HARQ feedback is transmitted over the PSFCH in response to the reception of a PSCCH/PSSCH transmission (when the receiver is the intended receiver). The required transmission power is calculated according with the PSFCH power control procedure (as described above in associated PSFCH power control procedure as specified in TS 38.213). However, similar to all transmissions taking place over the n46 and n96/n102 bands, the PSFCH transmission must also comply with the OCB and PSD regulations (as described above related to OCB and PSD requirements). In other words, the PSFCH transmission must occupy a minimum OCB of 2 MHz. However, as this limits the PSFCH maximum transmission power to 13 dBm, then ideally the selected OCB should be higher, allowing for higher PSFCH transmission powers.

In NR-U, in order to comply with the OCB and PSD regulations, an interlaced FDM scheme was adopted to all channels. Therefore, it is expected that the same solution will be applied to SL-U, i.e., the RBs belonging to a single sub-channel will be spread along (as an example) a 20 MHz bandwith. For a transmission of PSFCH, one PRB in a PSFCH symbol is used that carries a Zadoff-Chu sequence based on the sequences used for the physical uplink control channel (PUCCH) in Rel. 15 NR Uu (PUCCH format 0). In NR-U the interlace of the PUCCH format 0 was enabled by performing 10 repetitions equally spaced interlaces within the OCB (Occupied channel bandwidth). Therefore, a similar approach could be applied to the SL-U PSFCH.

However, the drawback of such approach is that the PSFCH capacity is reduced proportionally by Z the number of interlaces/repetitions required. Namely, the F PSFCH resources available for multiplexing the HARQ feedback for the PSSCH after applying the interlace can be determined for the two options as:
a) either based on the L PSSCH sub-channels used by a PSSCH, where the F can be computed as:

$$F = \frac{L PSSCH \cdot {M}_{set} \cdot Q}{Z}$$

Where,
   L PSSCH sub-channels of a PSSCH;
   Mₛₑₜ PRBs for PSFCH associated with each sub-channel; and
   Q cyclic shift pairs available in each PRB;
   Z is the number of interlaces/repetitions;
b) or based only on the starting sub-channel used by a PSSCH (i.e., based only on one sub-channel for the case when L PSSCH>1).

$$F = \frac{{M}_{set} \cdot Q}{Z}$$

F=Mₛₑₜ*Q PSFCHs (associated with the starting sub-channel of a PSSCH)
Where,
   Mₛₑₜ PRBs for PSFCH associated with each sub-channel; and
   Q cyclic shift pairs available in each PRB;
   Z is the number of interlaces/repetitions;

An alternative evaluation regarding the loss in PSFCH capacity due to interlace is that the available PRBs per sub-channel (let's call it R) to be used for PSFCH are reduced by a factor of Z. Then the achievable Meet becomes Mₛₑₜ=(R/Z)/N. In contrast, without interleave the achievable Mₛₑₜ=R/N, where N corresponds to the PSFCH period.

Embodiments of the present disclosure may address the problem that arises with the PSFCH when applying interlaced FDM in SL-U in order to meet the OCB and PSD regulations explained in previous part.

For a transmission of PSFCH, one PRB in a PSFCH symbol is used that carries a Zadoff-Chu sequence based on the sequences used for the physical uplink control channel (PUCCH) in Rel. 15 NR Uu (PUCCH format 0). In NR-U the interlace of the PUCCH format 0 was enabled by performing 10 repetitions equally spaced in OCB.

The simplest solution mentioned above, and used by NR-U, that consists on repeating the same PSFCH over different RBs that are spread along the spectrum in order to utilize max power and comply with the regulations, is not efficient. As pointed out, this reduces the amount of RBs available for PSFCH by a factor of Z, where Z is the number of interlaces.

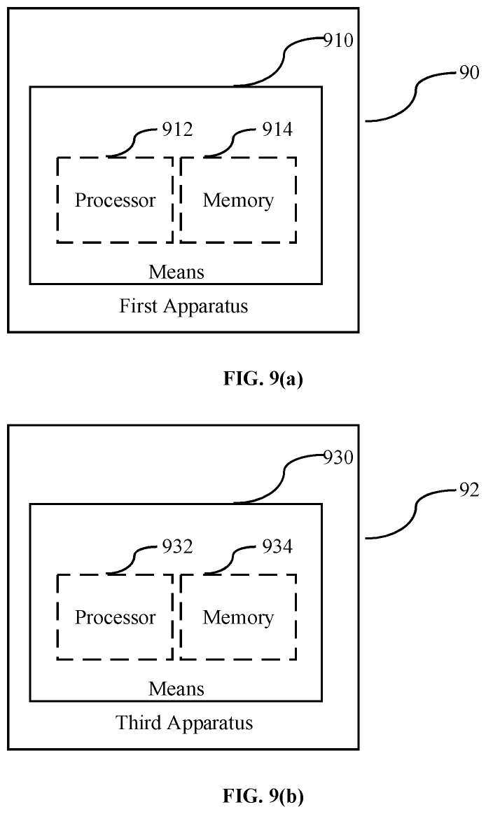

FIG. 9(a) is a block diagram showing an exemplary structure for the first apparatus, which is suitable for perform the method according to embodiments of the disclosure.

As shown in FIG. 9(a), the first apparatus 90 comprises means 910 for performing: receiving a transmission; transmitting a first feedback in response to the transmission. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

Embodiments herein afford many advantages. According to embodiments of the present disclosure, an improved manner for transmitting a feedback during wireless communication may be provided. Resource blocks may be reusable for more than one feedback from more than one apparatus. Thus, the number of required RBs to enable interlace/feedback may be reduced.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

Particularly, the primary resource block is the one that cannot overlap with any secondary resource blocks. None of the secondary resource blocks should overlap with none of the primary resource blocks, and none of the primary resource blocks should overlap between themselves. Only the secondary resource blocks could overlap with each other.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

In exemplary embodiments of the present disclosure, the means 910 comprises: at least one processor 912; and at least one memory 914 including computer program code. The at least one memory 914 and computer program code is configured to, with the at least one processor 912, cause the performance of the first apparatus.

The processor 912 may be any kind of processing component, such as one or more microprocessor or microcontrollers, as well as other digital hardware, which may include digital signal processors (DSPs), special-purpose digital logic, and the like. The memory 914 may be any kind of storage component, such as read-only memory (ROM), random-access memory, cache memory, flash memory devices, optical storage devices, etc.

According to embodiments of the present disclosure, for example, assuming that 100 RBs are available to be mapped for PSFCH transmission and that 10 RBs are required per interlace. With the proposed embodiments, up to 91 interlaces can be established, when assuming that the secondary PSFCH are mapped all to the same 9 RBs.

FIG. 9(b) is a block diagram showing an exemplary structure for the third apparatus, which is suitable for perform the method according to embodiments of the disclosure.

As shown in FIG. 9(b), the third apparatus 92 comprises means 930 for performing: transmitting a transmission to a first apparatus; receiving a first feedback in response to the transmission, from the first apparatus. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

The second apparatus, third apparatus may also comprise a UE using a side link unlicensed resource.

In exemplary embodiments of the present disclosure, the means 930 comprises: at least one processor 932; and at least one memory 934 including computer program code. The at least one memory and computer program code is configured to, with the at least one processor, cause the performance of the third apparatus.

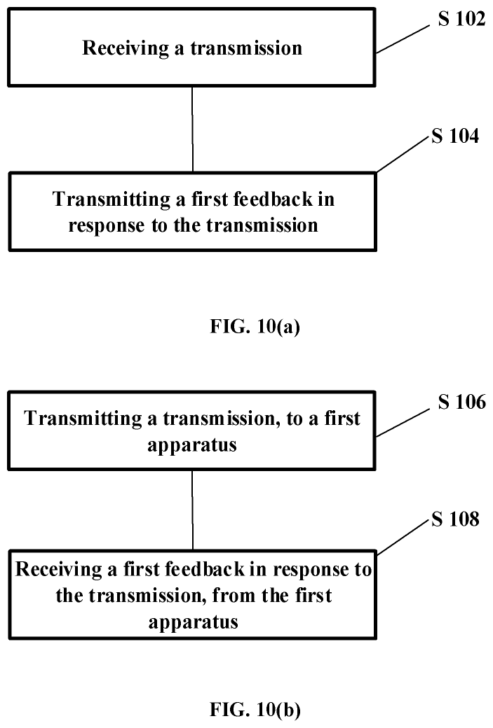

FIG. 10(a) is a flow chart illustrating a method performed by a first apparatus, in accordance with some embodiments of the present disclosure.

As shown in FIG. 10(a), the method performed by a first apparatus comprises: S102, receiving a transmission; S104, transmitting a first feedback in response to the transmission. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

FIG. 10(b) is a flow chart illustrating a method performed by a third apparatus, in accordance with some embodiments of the present disclosure.

As shown in FIG. 10(b), the method performed by a third apparatus comprises: S106, transmitting a transmission to a first apparatus; S108, receiving a first feedback in response to the transmission, from the first apparatus. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In exemplary embodiments of the present disclosure, the second feedback is transmitted by the second apparatus using a plurality of resource blocks comprising a third resource block, and at least one fourth resource block. The first resource block for the first feedback is in a first PSFCH subchannel. The second resource block for the first feedback is in a second PSFCH subchannel. The third resource block for the second feedback is in a third PSFCH subchannel. A fourth resource block in the at least one fourth resource block for the second feedback is in a fourth PSFCH subchannel. The first PSFCH subchannel is different with the third PSFCH subchannel. The first resource block is orthogonal to the third resource block. The second resource block overlaps with the fourth resource block.

In exemplary embodiments of the present disclosure, the first resource block is associated to a first PSSCH of the transmission received by the first apparatus. The second resource block is associated to the first PSSCH, and/or to the first resource block. The third resource block is associated to a second PSSCH of a transmission received by the second apparatus. The fourth resource block is associated to the second PSSCH, and/or to the third resource block.

In exemplary embodiments of the present disclosure, the first resource block is configured as a primary resource block reserved for the first feedback. The at least one second resource block is configured as at least one secondary resource block. The at least one secondary resource block is distributed in frequency domain. The at least one secondary resource block is preconfigured not to overlap with a primary resource block, or the first apparatus selects the at least one secondary resource block not overlapping with a primary resource block based on sensing result.

In exemplary embodiments of the present disclosure, the same content is transmitted in the first resource block and the second resource block. The same or different Zadoff-Chu sequence and/or cyclic shift are used for the first resource block and the second resource block.

In exemplary embodiments of the present disclosure, different contents are transmitted in the first resource block and the second resource block.

In exemplary embodiments of the present disclosure, each second resource block in the at least one second resource block is orthogonal with each other in code domain by applying different cyclic shifts.

In exemplary embodiments of the present disclosure, a power of the at least one second resource block and/or a number of the at least one second resource block are controlled, based on at least one of: a number of PSCCH/PSSCH transmissions detected by the first apparatus, and/or a power required by a HARQ transmission, and/or a resource pool occupancy level.

In exemplary embodiments of the present disclosure, a guard band is configured beside the second resource block.

In exemplary embodiments of the present disclosure, a position for the second resource block in a PSFCH subchannel is preconfigured. The second resource block is muted when a distance from the second resource block to the first resource block is less than a preconfigured threshold.

In exemplary embodiments of the present disclosure, the feedback is a HARQ feedback. The first apparatus comprises a user equipment, UE, using a side link unlicensed resource.

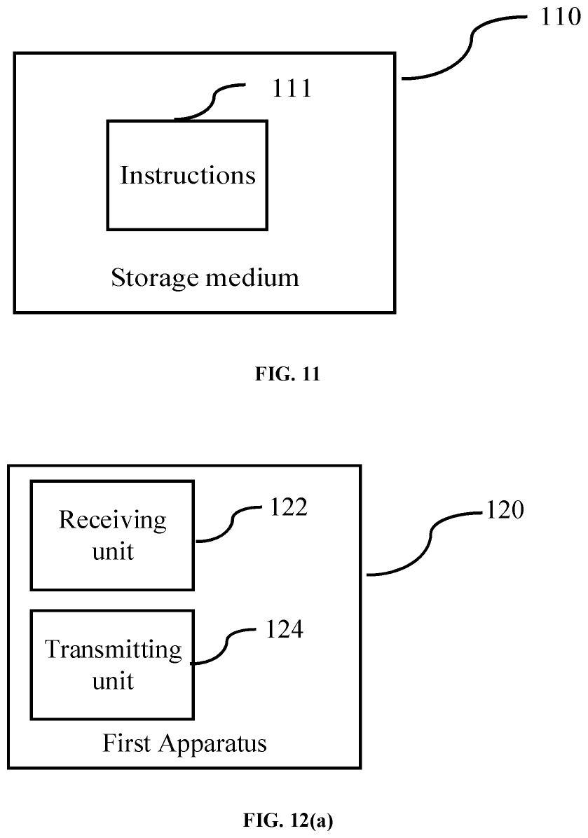

FIG. 11 is a block diagram showing an apparatus/computer readable storage medium, according to embodiments of the present disclosure.

As shown in FIG. 11, the computer-readable storage medium 110 stores instructions 111, which when executed by at least one processor of a first apparatus, cause the at least one processor of the first apparatus to perform: receiving a transmission; transmitting a first feedback in response to the transmission; or when executed by at least one processor of a third apparatus, cause the at least one processor of the third apparatus to perform: transmitting a transmission to the first apparatus; receiving the first feedback in response to the transmission, from the first apparatus. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In exemplary embodiments of the present disclosure, the transmission is a Physical Sidelink Shared Channel (PSSCH) transmission, together with a Physical Sidelink Control Channel (PSCCH) transmission. The first feedback is Physical Sidelink Feedback Channel (PSFCH) feedback. A resource location of the plurality of resource blocks is derived from a resource location of the PSSCH transmission and/or the PSCCH transmission.

In addition, the present disclosure may also provide a carrier containing the computer program/instructions as mentioned above. The carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

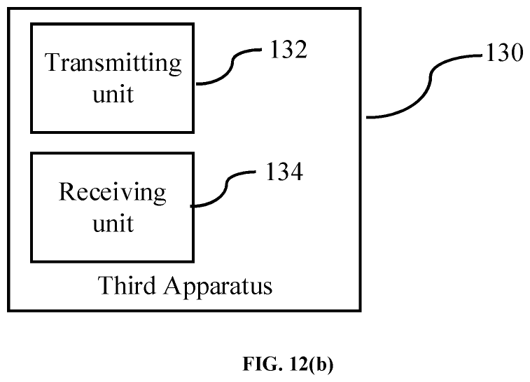

FIG. 12(a) is a block diagram showing exemplary apparatus units for the first apparatus, which is suitable for perform the method according to embodiments of the disclosure.

As shown in FIG. 12(a), the first apparatus 120 comprises: a receiving unit 122, configured to receive a transmission; and a transmitting unit 124, configured to transmit a first feedback in response to the transmission. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In embodiments of the present disclosure, the apparatus 120 is further operative to perform the method according to any of the above embodiments, such as these shown with FIG. 10(a).

FIG. 12(b) is a block diagram showing exemplary apparatus units for the third apparatus, which is suitable for perform the method according to embodiments of the disclosure.

As shown in FIG. 12(b), the third apparatus 130 comprises: a transmitting unit 132, configured to transmit a transmission, to a first apparatus; and a receiving unit 134, configured to receive a first feedback in response to the transmission, from the first apparatus. The first apparatus uses a plurality of resource blocks to form an interlace for the first feedback. The plurality of resource blocks comprises a first resource block, and at least one second resource block. A second resource block in the at least one second resource block is configured to be reusable for the first feedback, and a second feedback transmitted by a second apparatus.

In embodiments of the present disclosure, the apparatus 130 is further operative to perform the method according to any of the above embodiments, such as these shown with FIG. 10(b).

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

As used in the present disclosure, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in the present disclosure, including in any claims. As a further example, as used in the present disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

With these units, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Further detailed embodiments of the present disclosure may propose a solution for meeting the OCB and PSD requirements defined in unlicensed spectrum regulation, by enabling the SL-U UE to apply the interlaced FDM for the PSFCH transmissions, while coping with the reduction in PSFCH capacity.

It is proposed that each PSSCH transmission has a mapping to a PSFCH slot and a set of RBs that form an interlace. In this interlace, there is one RB that takes the role of primary PSFCH RB, while the remaining RBs take the role of secondary RBs.

The primary PSFCH RB associated with a PSSCH subchannel, is orthogonal to the primary PSFCH RBs associated with another PSSCH subchannel. This mapping may be according to Rel16 specifications. While, the secondary PSFCH RBs associated with a PSSCH subchannel, may completely or partially overlap the secondary PSFCH RBs associated with other PSSCH subchannels.

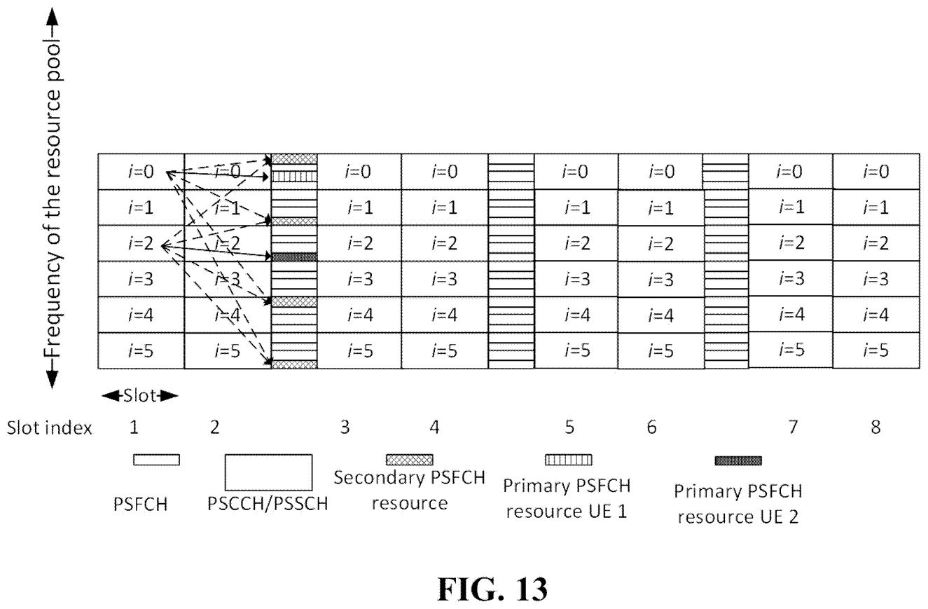

FIG. 13 is a diagram showing a partial non-orthogonal interlaced FDM PSFCH.

The proposed mapping is depicted in FIG. 13 for the case where UE 1 and UE 2 select the subchannel i=0 and i=2 at slot 1, respectively. In this figure, the x-axis represents the different slots and the y-axis represents the different sub-channels of the resource pool. The bigger squares are a PSSCH/PSCCH slot and the smaller squares are RBs dedicated for PSFCH.

In conclusion, the embodiments minimize the amount of RBs used to apply the interlaced FDM, maximizing in that way the capacity of the PSFCH or allowing the resources to be used by other SL-U UEs or even other technologies as WiFi.

Further, the SL-U Rx UE provides HARQ feedback for a received PSSCH transmission in the PSFCH RBs mapped to the subchannel(s) where the PSSCH transmission took place.

There may be a primary PSFCH RB mapping to the subchannel(s) where the PSSCH transmission took place. This mapping may follow the Rel. 16 specifications (as provided in TS 38.331 V16.8.0, etc.).

There may be a secondary PSFCH RB mapping to the subchannel(s) where the PSSCH transmission took place. This is a novel mapping provided by the embodiments, and may have the following characteristics:
The secondary PSFCH RBs may be reused by different SL-U UEs in order to minimize the amount of RBs occupied to apply the interlaced FDM and for the selection several options are proposed:
   PSFCH resource configuration may include several secondary PSFCH RBs that will not be used by any UE as the primary PSFCH resources. These reserved PSFCH RBs should be distributed in frequency domain of SL-U channel; or
   Each Rx UE may select the secondary PSFCH RBs based on sensing result (i.e. based on received PSCCH, Rx UE can estimate which PSFCH RB will not be used as primary PSFCH RB by other UEs in proximity and select them as its secondary PSFCH RBs). The selected secondary PSFCH RBs should be distributed in frequency domain of SL-U channel too.

The transmission content taking place in the primary PSFCH RB, is the same as in the secondary PSFCH RB. However, the physical signal characteristics can be:
The same Zadoff-Chu sequence/cyclic shift is used in the primary and secondary PSFCH RBs;
Different Zadoff-Chu sequences/cyclic shifts are used to distinguish between primary and secondary PSFCH RBs.

In an alternative embodiment, instead of repeating HARQ feedback in secondary RBs, all UEs transmitting feedbacks may additionally transmit common signal/channel, e.g., shortened/simplified PSBCH, sync signals, COT sharing related information.

The PSFCH secondary RBs associated with a PSSCH subchannel(s) can be orthogonalized in the code domain by applying different cyclic shifts.

In another embodiment, the Tx power of secondary PSFCH can be controlled based on the number of PSCCH/PSSCH transmissions detected to limit the total Tx power in secondary PSFCH resources.

Finally, the performance of the HARQ feedback is guaranteed by having the main PSFCH RB dedicated to ACK/NACK a single PSSCH slot, while the secondary RBs are used to enable the interlaced FDM and increased transmission power.

In an embodiment, Rx UE may adaptively select the number of secondary PSFCH resources based on the number of PSCCH/PSSCH transmissions detected. With the limited number of Rx UEs using the same secondary PSFCH, is it possible to detect HARQ feedback of each Rx UE if different sequence (or same sequence with different cyclic shift) is used by different Rx UE.

In some cases, the transmission from multiple UEs in the same secondary PSFCH may lead to high energy leakage to the neighbor PRBs next to the secondary PSFCH resource. So, in some implementation there can be a guard band (e.g., 1 PRB) before/after the secondary PSFCH resource. Alternatively, power control can be used to reduce the transmit power in the secondary PSFCH resource depending on the number of UEs allocated to use it.

The number of used secondary PSFCH RBs can be based on the amount of power required by the Rx HARQ transmission.

The use of subchannels to transmit PSSCH that require HARQ feedback can be restricted by the resource pool occupancy level (i.e., based on the Tx UE's measured CBR (Channel Busy Rate)). In case of low CBR, any subchannel can be used to transmit a PSSCH with HARQ feedback. However, in case of higher CBR, some subchannels will be restricted from PSSCH transmission that require HARQ feedback. This will ensure that the level of overlapped secondary PSFCH transmissions is such that the corresponding Tx can still detect the associated sequences.

The use of non-uniform interlaces introduces some RF challenges at the receiver side. However, the use of uniform interlaces has the drawback of not minimizing inter-band emissions. So, both approaches have issues.

However, a uniform interlace simplifies the RF design and as such it is proposed that the secondary PSFCH RBs follow a uniform interlace. For example, the upper (or lower) RB associated with each subchannel. While the primary PSFCH RB follows the PSSCH subchannel to PSFCH mapping as specified in Rel. 16.

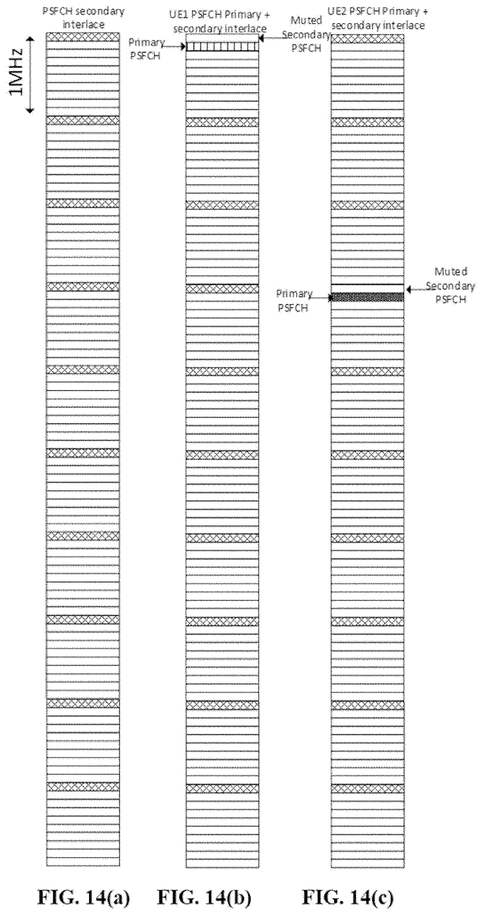

FIG. 14(a) is a diagram showing quasi-uniform interlace FDM PSFCH for NR-U (subcarrier spacing 15 KHz), with a set of RBs for secondary PSFCH; FIG. 14(b) is a diagram showing quasi-uniform interlace FDM PSFCH for NR-U (subcarrier spacing 15 KHz), with UE1 PSFCH primary and secondary interlace; FIG. 14(c) is a diagram showing quasi-uniform interlace FDM PSFCH for NR-U (subcarrier spacing 15 KHz), with UE2 PSFCH primary and secondary interlace.

The overlap of the secondary PSFCH RB interlace (uniform) and primary PSFCH RB leads to a quasi-uniform interlace. An example is illustrated in FIG. 14(a), FIG. 14(b), FIG. 14(c), where the left figure FIG. 14(a) shows the set of secondary PSFCH, the middle FIG. 14(b) and right figure FIG. 14(c) show the primary and secondary PSFCH used for UE1 and UE2 respectively.

Additionally, to ensure quasi-uniform interlace, then any secondary PSFCH RB at lower distance than X RBs from the primary PSFCH RB is muted.

The main benefit of the proposed embodiments of the present disclosure may include that it greatly reduces the number of required RBs to enable interlace. For example, assuming that 100 RBs are available to be mapped for PSFCH transmission and that 10 RBs are required per interlace. Then in the legacy approach, at most 10 interlaces could be established. In contrast, with the proposed approach up to 91 interlaces can be established, when assuming that the secondary PSFCH are mapped all to the same 9 RBs. However, it is expected a lower number of interlaces can be achieved (i.e. <91), especially if the secondary PSFCH do not completely overlap with each other.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

| ABBREVIATION | EXPLANATION |
|---|---|
| ACK | Acknowledge |
| COT | Channel Occupancy Time |
| FDM | Frequency Division Multiplexing |
| HARQ | Hybrid Acknowledge Request |
| NACK | Not Acknowledge |
| NR-U | New Radio Unlicensed |
| OCB | Occupied Channel Bandwidth |
| PSCCH | Physical Sidelink Control Channel |
| PSD | Power Spectral Density |
| PSFCH | Physical Sidelink Feedback Channel |
| PSSCH | Physical Sidelink Shared Channel |
| PUCCH | Physical Uplink Control Channel |
| RB | Resource Block |
| Rx UE | Receiver User Equipment |
| SCS | SubCarrier Spacing |
| SL-U | Sidelink Unlicensed |
| Tx UE | Transmitter User Equipment |
| WG | Working Group |
| FR1 | Frequency Range 1 |

1-52. (canceled)

53. A first apparatus comprising:
at least one processor; and at least one memory, the at least one memory storing instructions, that when executed by the at least one processor, cause the first apparatus to:
receive a transmission;
transmit a first feedback in response to the transmission:
wherein the first apparatus uses a plurality of resource blocks to form a Physical Sidelink Feedback Channel (PSFCH) transmission for the first feedback;
wherein the plurality of resource blocks comprises a first resource block, and at least one second resource block;
wherein a second resource block in the at least one second resource block is configured to be reusable for the first feedback, and for a second feedback of a second apparatus.

54. The first apparatus according to claim 53,
wherein the transmission is a Physical Sidelink Shared Channel (PSSCH) transmission, together with a Physical Sidelink Control Channel (PSCCH) transmission;
wherein a resource location of the plurality of resource blocks is derived from a resource location of the PSSCH transmission and/or the PSCCH transmission.

55. The first apparatus according to claim 53,
wherein the second feedback is transmitted by the second apparatus using a plurality of resource blocks comprising a third resource block, and at least one fourth resource block;
wherein the first resource block for the first feedback is in a first PSFCH subchannel;
wherein the second resource block for the first feedback is in a second PSFCH subchannel;
wherein the third resource block for the second feedback is in a third PSFCH subchannel;
wherein a fourth resource block in the at least one fourth resource block for the second feedback is in a fourth PSSCH subchannel;
wherein the first PSFCH subchannel is different with the third PSFCH subchannel;
wherein the first resource block is orthogonal to the third resource block; and
wherein the second resource block overlaps with the fourth resource block.

56. The first apparatus according to claim 55,
wherein the first resource block is associated to a first PSSCH of the transmission received by the first apparatus;
wherein the second resource block is associated to the first PSSCH, and/or to the first resource block;
wherein the third resource block is associated to a second PSSCH of a transmission received by the second apparatus;
wherein the fourth resource block is associated to the second PSSCH, and/or to the third resource block.

57. The first apparatus according to claim 53,
wherein the first resource block is configured as a primary resource block reserved for the first feedback;
wherein the at least one second resource block is configured as at least one secondary resource block;
wherein the at least one secondary resource block is distributed in frequency domain;
wherein the at least one secondary resource block is preconfigured not to overlap with a primary resource block, or the first apparatus selects the at least one secondary resource block not overlapping with a primary resource block based on sensing result.

58. The first apparatus according to claim 53,
wherein the same content is transmitted in the first resource block and the second resource block; and
wherein a same or different Zadoff-Chu sequence and/or cyclic shift are used for the first resource block and the second resource block.

59. The first apparatus according to claim 53,
wherein different contents are transmitted in the first resource block and the second resource block.

60. The first apparatus according to claim 53,
wherein each second resource block in the at least one second resource block is orthogonal with each other in code domain by applying different cyclic shifts.

61. The first apparatus according to claim 53,
wherein a power of the at least one second resource block and/or a number of the at least one second resource block are controlled, based on at least one of:
a number of PSCCH/PSSCH transmissions detected by the first apparatus, and/or
a power required by a HARQ transmission, and/or
a resource pool occupancy level.

62. The first apparatus according to claim 53,
wherein a guard band is configured beside the second resource block.

63. The first apparatus according to claim 53,
wherein a position for the second resource block in a PSFCH subchannel is preconfigured; and/or
wherein the second resource block is muted when a distance from the second resource block to the first resource block is less than a preconfigured threshold.

64. The first apparatus according to claim 53,
wherein the feedback is a Hybrid Acknowledge Request feedback; and/or
wherein the first apparatus comprises a user equipment, UE, using a side link unlicensed resource.

65. A method performed by a first apparatus, comprising:
receiving a transmission:
transmitting a first feedback in response to the transmission;
wherein the first apparatus uses a plurality of resource blocks to form a Physical Sidelink Feedback Channel (PSFCH) transmission for the first feedback;
wherein the plurality of resource blocks comprises a first resource block, and at least one second resource block;
wherein a second resource block in the at least one second resource block is configured to be reusable for the first feedback, and for a second feedback of a second apparatus.

66. The method according to claim 65,
wherein the transmission is a Physical Sidelink Shared Channel (PSSCH) transmission, together with a Physical Sidelink Control Channel (PSCCH) transmission:
wherein a resource location of the plurality of resource blocks is derived from a resource location of the PSSCH transmission and/or the PSCCH transmission.

67. The method according to claim 65,
wherein the second feedback is transmitted by the second apparatus using a plurality of resource blocks comprising a third resource block, and at least one fourth resource block;
wherein the first resource block for the first feedback is associated to a first PSSCH subchannel;
wherein the second resource block for the first feedback is associated to a second PSSCH subchannel;
wherein the third resource block for the second feedback is associated to a third PSSCH subchannel;
wherein a fourth resource block in the at least one fourth resource block for the second feedback is associated to a fourth PSSCH subchannel;
wherein the first PSSCH subchannel is different with the third PSSCH subchannel;
wherein the first resource block is orthogonal to the third resource block; and
wherein the second resource block overlaps with the fourth resource block.

68. The method according to claim 67,
wherein the first resource block is associated to a first PSSCH of the transmission received by the first apparatus;
wherein the second resource block is associated to the first PSSCH, and/or to the first resource block;
wherein the third resource block is associated to a second PSSCH of a transmission received by the second apparatus;
wherein the fourth resource block is associated to the second PSSCH, and/or to the third resource block.

69. The method according to claim 65,
wherein the first resource block is configured as a primary resource block reserved for the first feedback;
wherein the at least one second resource block is configured as at least one secondary resource block;
wherein the at least one secondary resource block is distributed in frequency domain;
wherein the at least one secondary resource block is preconfigured not to overlap with a primary resource block, or the first apparatus selects the at least one secondary resource block not overlapping with a primary resource block based on sensing result.

70. The method according to claim 65,
wherein the same content is transmitted in the first resource block and the second resource block; and
wherein a same or different Zadoff-Chu sequence and/or cyclic shift are used for the first resource block and the second resource block.

71. The method according to claim 65,
wherein different contents are transmitted in the first resource block and the second resource block.

72. A third apparatus comprising:
at least one processor; and at least one memory, the at least one memory storing instructions, that when executed by the at least one processor, cause the third apparatus to:
transmit a transmission, to a first apparatus;
receive a first feedback in response to the transmission, from the first apparatus;
wherein the first apparatus uses a plurality of resource blocks to form a Physical Sidelink Feedback Channel (PSFCH) transmission for the first feedback;
wherein the plurality of resource blocks comprises a first resource block, and at least one second resource block;
wherein a second resource block in the at least one second resource block is configured to be reusable for the first feedback, and for a second feedback of a second apparatus.
